(19) United States
(12) Patent Application Publication
(10) Pub. No.: US 2012/0106335 A1
(43) Pub. Date: May 3, 2012

(54) Method and device for acknowledging a periodic signaling request in a telecommunication network

(75) Inventors: Bertrand Bouvet, Perros Guirec (FR); Fabrice Petesch, Rospez (FR)

(73) Assignee: France Telecom, Paris (FR)

(21) Appl. No.: 13/381,546

(22) PCT Filed: Jun. 25, 2010
(86) PCT No.: PCT/FR10/51302

§ 371 Date: Dec. 29, 2011

(30) Foreign Application Priority Data
Jun. 30, 2009 (FR) 0954447

(51) Int. Cl. H04W 28/02; H04W 60/00

(52) U.S. Cl. 370/230; 370/328

(57) ABSTRACT

A method that may be implemented in a CSCF entity to acknowledge a REGISTER type request sent by a terminal. It comprises: a step (E30) of estimating, for at least one future time window, the number of REGISTER requests that are liable to be received by the CSCF entity during said future time window; a step of selecting a future time window; and a step (E110) of sending to the sending terminal an acknowledgment message (200, 503) including a period (EXPIRES) selected so that the next REGISTER request sent by that terminal will be sent during said selected future window.

### BACKGROUND OF THE INVENTION

The present invention lies in the field of managing signaling traffic in telecommunications networks.

It applies particularly, but in non-limiting manner, to networks that implement the session initiation protocol (SIP), and for example it applies to Internet protocol (IP) multimedia subsystem networks (IMS).

In known manner, access by a terminal to services made available in an IMS network requires the terminal to be registered with call session control function (CSCF) equipment in the core of the IMS network, and then the terminal possibly subscribing to one or more service bricks.

The procedure for registering a user agent (UA) terminal with an IMS CSCF call service platform is described below with reference to FIG. 1. This procedure starts with a first SIP REGISTER request being sent, which is acknowledged by a type 401 (Nonce) message, and then by an acknowledged REGISTER (authentication) request being sent in the event of success by means of a message of the 200 OK type.

In the context of the SIP protocol, it should be recalled that messages of type 401 (Nonce) and of type 200 OK are also known as response codes.

It should be observed that the 200 OK acknowledgment message includes a duration EXPIRES whereby the CSCF defines the period within which the UA terminal must send two successive REGISTER requests. It is important to understand that regular sending of these REGISTER messages is necessary in order to maintain the context of the UA terminal within the CSCF. This EXPIRES duration is constant, and is of the order of 3600 seconds (s). On receiving such a message, the UA terminal determines a renewal value. By way of example, this value may be selected to be equal to:

EXPIRES−600 s, if EXPIRES>1200 s; or

EXPIRES/2, if EXPIRES≦1200 s.

In the example of FIG. 1, the renewal duration is thus determined to be equal to 3000 s.

In entirely comparable manner, the method whereby a UA terminal subscribes with a service brick, shown in FIG. 2, requires SIP SUBSCRIBE requests to sent regularly to said service brick, with the period between two consecutive requests, as defined by the service brick, being constant and of the order of 86400 s (i.e. 24 hours (h)) for a service of the message waiting indicator (MWI) type. On receiving a response message 200 OK (EXPIRES), the UA terminal determines a renewal value that is selected, for example, to be equal to:

EXPIRES−600 s, if EXPIRES>1200 s; or

EXPIRES/2, if EXPIRES≦1200 s.

In the example of FIG. 2, the renewal duration is determined to be equal to 24 h-600 s.

Given the very large number of UA terminals, the signaling traffic associated with regularly sending SIP REGISTER and SIP SUBSCRIBE requests through the network ought to have a tendency to smooth out naturally in the CSCF network core and in the service bricks.

In practice, that is not so, and the Applicant has observed strong variations in this traffic.

By way of example, it is known that very high levels of re-registration requests are to be observed in the morning (a non-negligible proportion of users are in the habit of switching off their terminals at night) or in the event of a breakdown of central equipment in the core network.

The number of users impacted and seeking to re-register simultaneously can then be very large, e.g. of a order of a few millions.

It should be observed that the SIP renewal procedure as defined in document RFC 3261 requires a terminal to re-send a non-acknowledged SIP REGISTER request ten times at a pre-established rate in stages of 32 s, with these being repeated in application of a non-standardized protocol.

Furthermore, equipment in the core network, and in particular the CSCFs and in the home subscriber servers (HSSs), by its very nature, presents capacity that enables it to process some maximum number of SIC REGISTER registration requests per second.

From the point of view of the network operator, it is very important to seek to maintain signaling traffic that enables the operator to absorb any variations that are likely to occur. In the event of a breakdown, it is also crucial to be able to put into place a breakdown exit procedure that makes it possible to return quickly to a stable situation that offers a satisfactory quality of services to users.

Unfortunately, no satisfactory solution is known at present.

### OBJECT AND SUMMARY OF THE INVENTION

In a first aspect, the invention provides a method suitable for implementing in an entity of a telecommunications network in order to acknowledge a request of a determined type sent by a terminal and received by the entity, a request of the same type being liable to be re-sent by the terminal after a time period as defined by the entity and sent to the terminal in a message acknowledging the request. The method comprises:

a step of receiving a request of this type, referred to as a current request;

a step of estimating, for at least one future time window, the number of requests of the type that are liable to be received by the entity during the future time window;

a step of selecting one of the future time windows; and

a step of sending to the terminal that sent the current request, an acknowledgment message including a period selected so that the next request of this same type as sent by the terminal will be sent during the selected future window.

Correspondingly, the invention provides an entity of a telecommunications network, the entity including:

receiver means for receiving a request of a determined type sent by a terminal, referred to as the current request, the request being liable to be re-sent by the terminal after a time period defined by the entity and sent to the terminal in an acknowledgment message acknowledging the request;

estimation means for estimating, for at least one future time window, the number of requests of the type that are liable to be received by the entity during the future time window;

selection means for selecting one of these future time windows; and

sender means for sending an acknowledgment message to the terminal, the acknowledgment message including a period selected so that the next request of the same type as sent by the terminal will be sent during the selected future window.

In other words, and in very general manner, the invention proposes no longer systematically acknowledging a periodic request with a fixed period, but rather adjusting this period as a function of predicted future traffic generated by these requests.

It should be observed that in this document, an “acknowledgment message” may be a positive acknowledgment message or a negative acknowledgment message, i.e. a rejection message. For example, the response codes 200 and 503 of the SIP protocol are both acknowledgment messages in the meaning of the invention.

In a particular implementation, the acknowledgment method of the invention further includes an observation step consisting in counting for each time period of an observation stage the number of requests of a determined type that are received by said entity during said time period, with the number of requests of this type that are liable to be received by said entity during a future time window being estimated on the basis of this observation.

The future time window selected by the entity for receiving the next request sent by a terminal may for example be a window such that the estimated number of requests is less than an average value as calculated over the entire observation stage.

Advantageously, the invention may be implemented by a CSCF entity or by a service brick in order to smooth SIP REGISTER requests or SIP SUBSCRIBE requests sent by the terminals managed by these entities.

Consequently, the invention provides a CSCF entity comprising:

observation means suitable for counting the number of SIP REGISTER requests received per second during an observation stage;

receiver means for receiving a current SIP REGISTER request from a terminal; and

sender means for sending to the terminal, in response to the current request, an acknowledgment message including a period selected so that the next SIP REGISTER request sent by the terminal will be sent during a time window such that the estimated number of SIP REGISTER requests that are liable to be received by said CSCF entity during the time window is less than or equal to an average value of the number of SIP REGISTER requests received during the observation stage.

The number of SIP REGISTER requests received per second is often known by the acronym RAPS (register attempts per second).

The invention also provides a service brick in an SIP signaling network, the brick including:

observation means suitable for counting the number of SIP SUBSCRIBE requests received per second during an observation stage;

receiver means for receiving a current SIP SUBSCRIBE request from a terminal; and

sender means for sending to the terminal, in response to the current request, an acknowledgment message including a period selected so that the next SIP SUBSCRIBE request sent by the terminal will be sent during a time window such that the estimated number of SIP SUBSCRIBE requests liable to be received by the service brick during the time window is less than or equal to an average value for the number of SIP SUBSCRIBE requests received during the observation stage.

The number of SIP SUBSCRIBE requests received per second is often known under the acronym SAPS (subscribe attempts per second).

These methods for smoothing or re-balancing SIP REGISTER or SIP SUBSCRIBE requests may be implemented at any time in order to avoid drift in the network. In particular, they may be implemented at the end of the morning in order to smooth the signaling traffic induced by terminals being switched on at the very beginning of the morning.

The invention also proposes solutions for returning quickly to a satisfactory state on exiting a breakdown.

To this end, the invention provides an acknowledgment method implemented by an entity and comprising:

a step of starting an observation stage, the observation stage having a duration equal to a nominal time period as defined by the entity for the requests that are of a priority type; and

a step of calculating the current number of requests of this priority type received by the entity during a predetermined duration preceding the reception of a current request.

The period that is sent to the terminal sending this request is then:

a first value greater than the nominal value if the current request is not of the priority type;

a second value, greater than the first value, if the current request is of the priority type, the current number of priority type requests being less than or equal to a maximum number of requests of the priority type that can be processed by the entity during the determined duration; or

the nominal value if the current request is a request of the priority type and the current number of priority type requests is greater than the maximum number.

By way of example, this method may be implemented by a CSCF entity exiting a breakdown of equipment in the core network in order to process SIP REGISTER requests as a priority to the detriment of SIP SUBSCRIBE requests.

Consequently, the invention provides an CSCF type entity including:

starter means for starting an observation stage having a duration equal to a nominal time period as defined by the CSCF entity for SIP REGISTER requests;

the period sent to a terminal response to an SIP SUBSCRIBE or an SIP REGISTER request being:

a first value greater than the nominal value if the current request is an SIP SUBSCRIBE request;

a second value greater than the first value if the current request is an SIP REGISTER request, the number RAPS of SIP REGISTER requests received by the CSCF entity during the second preceding the reception of the current request being less than or equal to the maximum number of SIP REGISTER requests that can be processed by the CSCF entity in one second; or

the nominal value if the current request is an SIP REGISTER request, the number RAPS of SIP REGISTER requests received by the CSCF entity during the second preceding the reception of the current request being greater than the maximum number of SIP REGISTER requests that can be processed by the CSCF entity in one second.

The first and second values may be selected empirically. In particular, they may be equal respectively to twice and to three times the nominal period.

Another solution according to the invention for managing an exit from a breakdown consists in pushing back requests from terminals that are already registered with an entity into a time window that is far enough away to make it possible to register the other terminals that are managed by that entity but that are not yet registered.

Consequently, the invention provides an acknowledgment method suitable for being implemented by an entity in a telecommunications network, and including:

a step of calculating, as a function of a maximum number of requests of a priority type that can be processed by the entity during a determined duration, minimum duration for processing the first requests of said priority type that are liable to be received from terminals that are managed by the entity but that are not registered in the network; and

a step of calculating the current number of requests of the priority type received by the entity during a determined duration preceding the reception of the current request;

the period sent to the terminal in the message acknowledging this request being:

a nominal value if the current number is less than or equal to the maximum number; or

the minimum duration if the current number is greater than said maximum number.

By way of example, this method may be implemented by a CSCF entity exiting a breakdown of equipment in the core network, in order to delay signaling traffic concerning SIP REGISTER and SIP SUBSCRIBE requests from terminals that are managed by the CSCF and that are not yet registered in the network.

Consequently, the invention also provides a CSCF type entity including:

calculation means for calculating as a function of the maximum number of SIP REGISTER requests that can be processed by the CSCF entity per second, a minimum duration for processing the first SIP REGISTER requests that are liable to be received from terminals that are managed by the CSCF entity but that are not registered in the network; and

calculation means for calculating the current number RAPS of SIP REGISTER requests received by the CSCF entity during the second preceding the reception of the current request;

the period sent to the terminal in the message acknowledging this request being:

a nominal value if the current number RAPS is less than or equal to the above-mentioned maximum number; or

the minimum duration if said current number RAPS is greater than the maximum number.

In a particular implementation, the various steps of the acknowledgment method are determined by computer program instructions.

Consequently, the invention also provides a computer program on a data medium, the program being suitable for being implemented in a CSCF entity, a service brick, or more generally in a computer, the program including instructions suitable for implementing the steps of the acknowledgment method as mentioned above.

The program may use any programming language, and it may be in the form of source code, object code, or code intermediate between source code and object code, such as in a partially compiled form, or in any other desirable form.

The invention also provides a computer readable data medium including instructions of a computer program as mentioned above.

The data medium may be any entity or device capable of storing the program. For example, the medium may include storage means such as a read only memory (ROM), e.g. a compact disk (CD) ROM or a microelectronic circuit ROM, or indeed magnetic recording means, e.g. a floppy disk or a hard disk.

Furthermore, the data medium may be a transmissible medium such as an electrical or optical signal, suitable for being conveyed via an electrical or optical cable, by radio, or by other means. The program of the invention may in particular be downloaded from an Internet type network.

Alternatively, the data medium may be an integrated circuit in which the program is incorporated, the circuit being adapted to execute or to be used in the execution of the method in question.

### BRIEF DESCRIPTION OF THE DRAWINGS

Other characteristics and advantages of the present invention appear from the description given below with reference to the accompanying drawings that show an implementation having no limiting character. In the figures:

FIG. 1, described above, shows a procedure for registering a terminal in an IMS network, this procedure being known in the state of the art;

FIG. 2, described above, shows a procedure for a terminal subscribing to a service brick in an IMS network, this procedure being known in the state of the art;

FIG. 3 is a diagram of a CSCF entity in accordance with the invention in a particular embodiment;

FIG. 4 is a diagram of a service brick in accordance with the invention in a particular embodiment;

FIG. 5 is a graph showing signaling traffic that can be observed in an IMS network in the prior art;

FIGS. 6A and 6B are flow charts showing the main steps of an acknowledgment method suitable for being implemented by the FIG. 3 CSCF entity;

FIG. 7 is a graph showing the effects of the acknowledgment method of FIG. 6 on the signaling traffic of FIG. 5;

FIGS. 8A and 8B are flow charts showing the main steps of an acknowledgment suitable for being implemented by the FIG. 4 service brick;

FIGS. 9 and 10 are flow charts showing the main steps of an acknowledgment method in accordance with the invention, suitable for being implemented by the FIG. 3 CSCF entity on exiting a breakdown; and

FIG. 11 is a flow chart showing the main steps of a variant of this method.

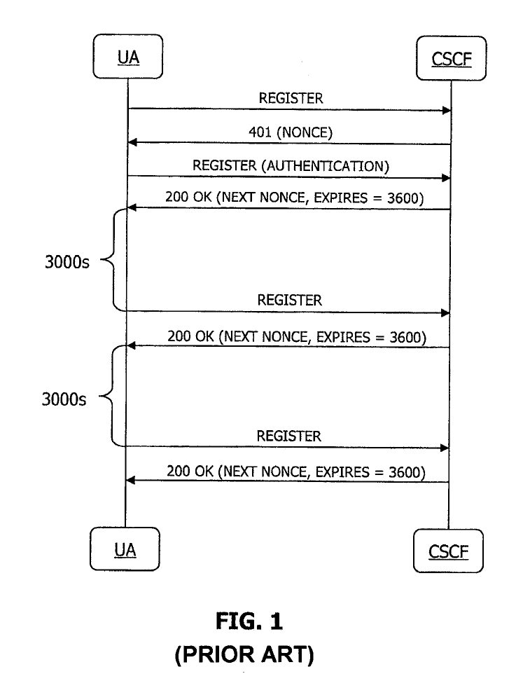

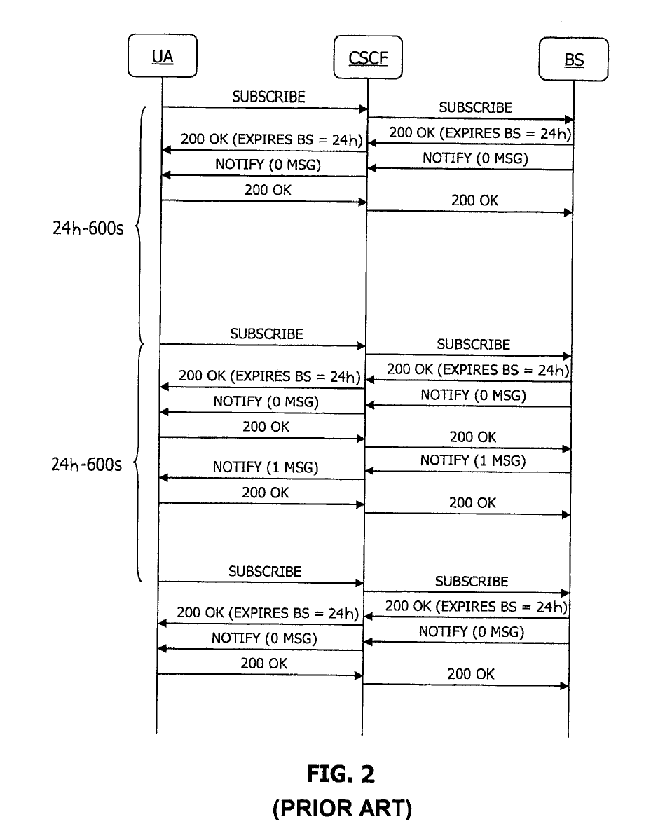

### DETAILED DESCRIPTION OF IMPLEMENTATIONS OF THE INVENTION

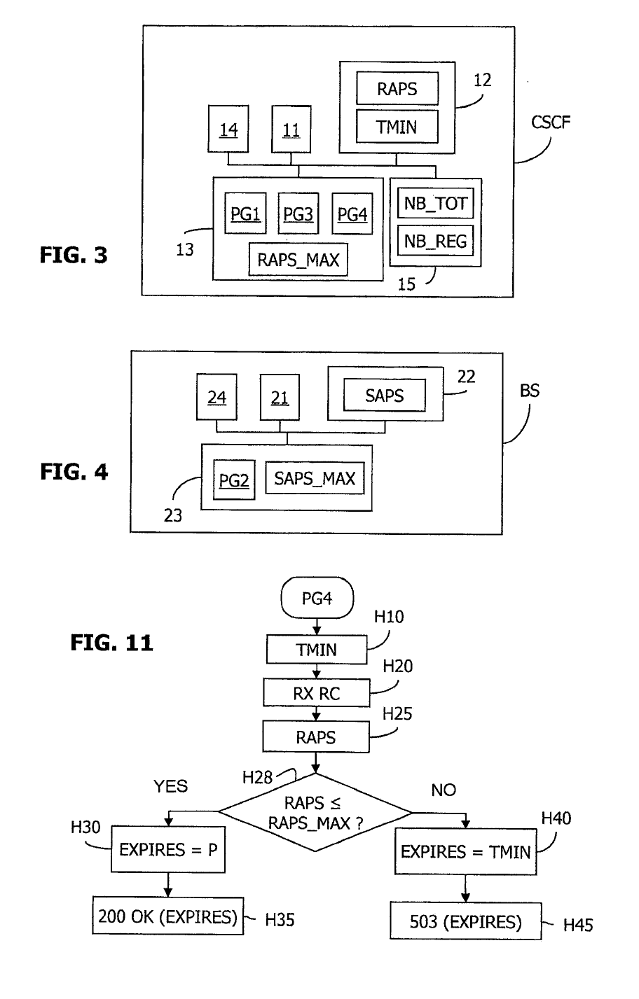

FIG. 3 shows a CSCF entity in accordance with a particular embodiment of the invention.

In the embodiment described here, the CSCF entity has the hardware architecture of a computer.

Specifically, it comprises a processor 11, random access memory (RAM) 12, ROM 13, communications means 14, and rewritable non-volatile memory 15 of the flash type.

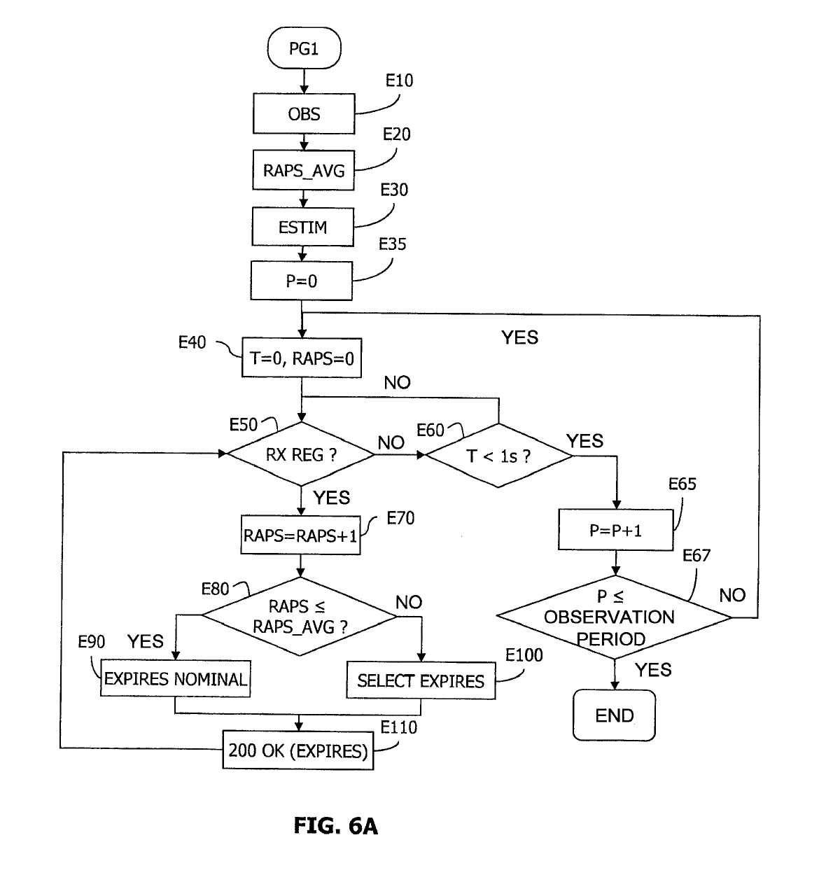

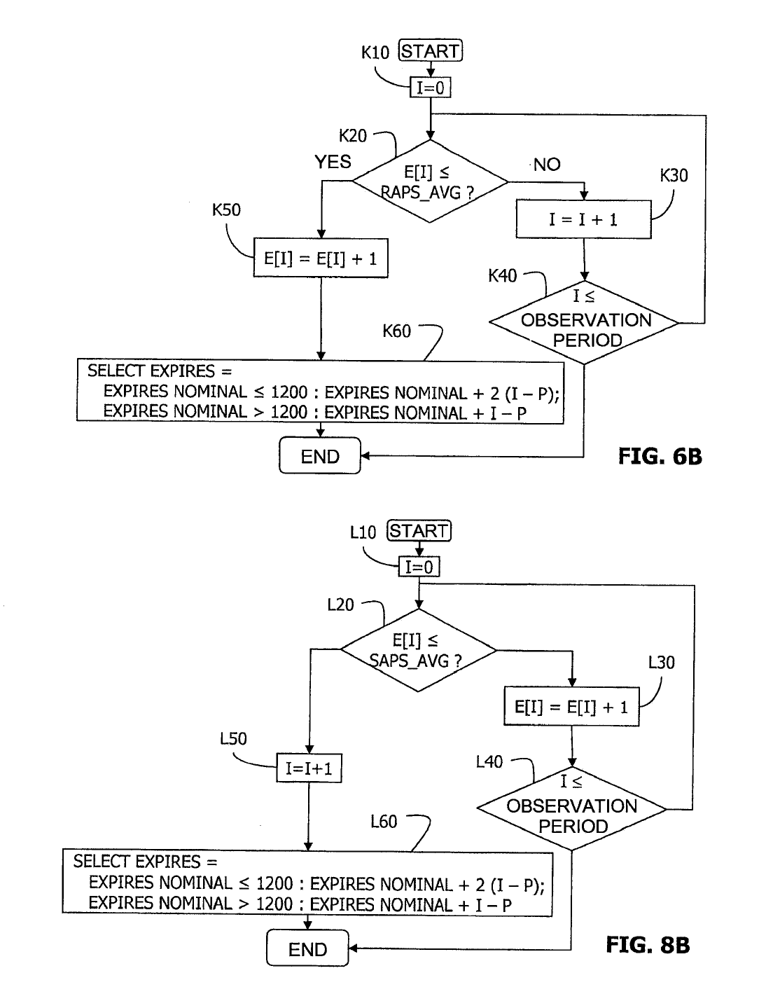

The ROM 13 constitutes a recording medium in accordance with the invention having three computer programs PG1, PG3, and PG4 recorded thereon, which programs are described below with reference to FIGS. 6, 8, and 9.

The ROM 13 also includes a register RAPS_MAX that stores the maximum number of REGISTER requests that can be processed by the CSCF entity per second.

The RAM 12 includes registers enabling the programs PG1, PG3, and PG4 to be executed by the processor 11.

In particular, it includes the following:

a register RAPS for storing the number of REGISTER requests received during the last second; and

a register TMIN that is described below with reference to FIG. 11.

In a particular embodiment, the rewritable non-volatile memory 15 includes two registers NB_TOT and NB_REG that are likewise described with reference to FIG. 11.

FIG. 4 shows a service brick BS in accordance with the invention, in a particular embodiment.

The service brick BS has a processor 21, RAM 22, ROM 23, and communications means 24.

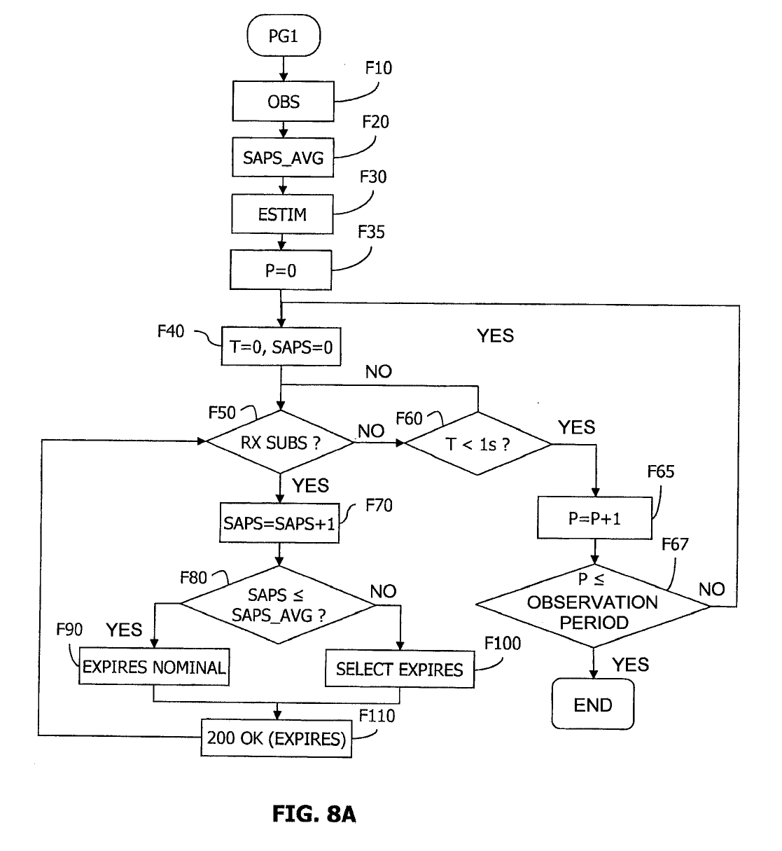

The ROM 23 constitutes a recording medium in accordance with the invention having a computer program PG2 recorded thereon, with the main steps of that program being described with reference to FIG. 8.

The ROM 23 also includes a register SAPS_MAX containing the maximum number of SUBSCRIBE requests that can be processed by the service brick BS in one second.

The RAM 22 includes registers enabling the program PG2 to be executed by the processor 21. In particular, it includes a register SAPS containing the number of subscription requests SUBSCRIBE that have been received by the brick BS during the last second.

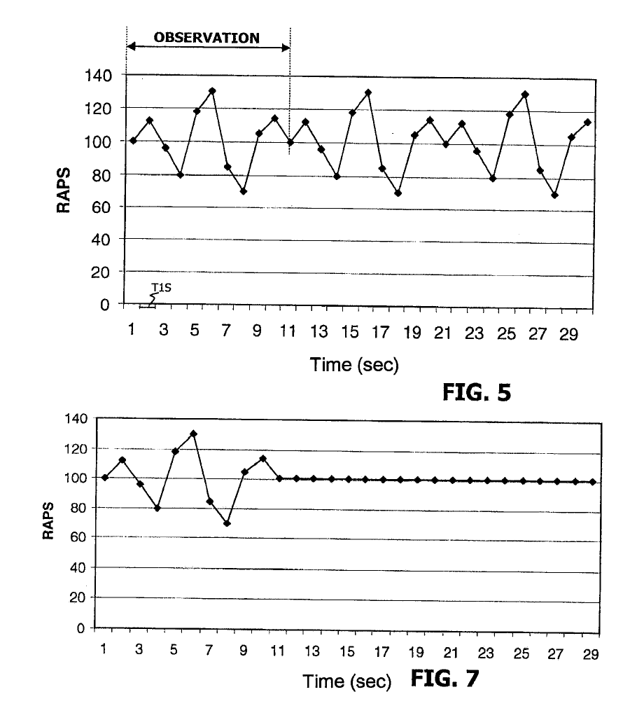

With reference to FIGS. 5 to 7, there follows a description of how a CSCF entity in accordance with the invention can implement an acknowledgment method in accordance with the invention in order to smooth the signaling traffic associated with the REGISTER requests send by the UA terminals that are managed by said entity.

In this first implementation, the CSCF entity acts in a step E10 to observe the above-mentioned signaling traffic.

With reference to FIG. 5, it is assumed that this observation stage has a duration of 10 s, measured from instant 0 s to instant 10 s.

During this observation stage, the CSCF entity counts the number RAPS of REGISTER requests that are received by the CSCF entity in each one-second period.

These values are marked in the graph of FIG. 5.

Then, during a step E20, the CSCF entity calculates the average value RAPS_AVG of the number of REGISTER requests received per second throughout the observation stage.

In the example described herein, this average number RAPS_AVG is equal to 101.

In this example, it is assumed that the 10 s duration of the observation stage corresponds to a constant EXPIRES period of 20 s that would have been sent by the CSCF entity in the messages acknowledging the REGISTER request if the invention were not implemented.

Under such circumstances, and assuming that no other terminal attempts to register with the CSCF entity, the signaling traffic for the future time periods following the observation stage would be entirely predictable, also assuming that no terminal de-registers.

More precisely, and as shown in FIG. 5, the traffic would repeat identically for each 10 s period.

In the implementation described herein, the acknowledgment method of the invention includes a step E30 during which the CSCF entity estimates the forthcoming future traffic by making the above-described assumptions (no new registrations, no de-registrations).

Consequently, and by way of example, the CSCF entity estimates that the number RAPS of REGISTER requests received between the fifteenth and the sixteenth seconds will be the same as the number received between the fifth and the sixth seconds, i.e. 130.

The object of the acknowledgment method described herein is to smooth the traffic of the REGISTER signaling request after the observation stage, with the result of this method being shown in FIG. 7.

During a step E35, the CSCF entity initializes a timer P to zero, the timer P being used to measure the duration of the observation period.

During a step E40, the CSCF entity initializes a timer T to zero, the timer T being used to measure the duration of one second, and it initializes a value RAPS that is stored in the RAM 12 to have the value zero.

The step E40 is followed by a step E50 during which the CSCF entity verifies whether or not it has received a REGISTER type request.

If not, the test E50 is followed by a test E60 during which the CSCF entity verifies whether more than one second has elapsed since the timer T was started.

If so, the result of the test E60 is positive. The timer P is then incremented by unity (step E65). Then, during a test E67, it is determined whether the observation period has elapsed. If so, the method terminates. Else, the method loops back to the step E40 in order to reinitialize the timer T and the register RAPS.

When the CSCF entity receives a REGISTER request, the result to the test E50 is positive. This test is then followed by a step E70 during which the variable RAPS is incremented by unity.

Consequently, the register RAPS continuously contains the number of REGISTER requests that have been received in the current second.

The step E70 is followed by a step E80 during which the CSCF entity verifies whether the number RAPS of REGISTER requests received during the last second is less than or equal to the average number RAPS AVG of REGISTER requests as calculated in step E20.

If so, the result of the test E80 is positive, and the CSCF entity sets the EXPIRES parameter to the nominal period, i.e. 20 s in this example (step E90).

In contrast, if during step E80 it is determined that the number RAPS of REGISTER requests received during the last second exceeds the maximum value RAPS MAX, then the CSCF entity acts during a general step E100 to set the EXPIRES parameter to take account of the estimate performed in step E30.

This general step is described below with reference to FIG. 6B.

In the example described herein, use is made of a table E[i] that is initialized for each second i of the observation stage with the number of REGISTER requests observed during the i^{th} second of the observation stage.

During a step K10, a variable I is initialized to 0 and a search is made in the table E[I] by means of a loop K20, K30, K40 for the first “slack” in the observation period relative to the average value RAPS AVG as calculated in step E20.

Once any such slack has been identified, the result of the test K20 is positive, and the slack is filled in by unity, during a step K50.

Thereafter, during a step K60, the EXPIRES value is calculated for sending to the UA terminal so as to take account of the position I of the slack, and of the time location P of the REGISTER request being processed. This calculation needs to take account of the internal processing of the EXPIRES parameter by the UA terminal. Specifically, in the implementation described herein, the CSCF entity sets the EXPIRES parameter as follows:

EXPIRES NOMINAL+(I−P), if EXPIRES NOMINAL is strictly greater than 1200; and

EXPIRES NOMINAL+2(I−P), if EXPIRES NOMINAL is less than or equal to 1200.

The step K60 terminates the general step E100.

An acknowledgment message is sent to the UA terminal concerned during a step E110, which message includes the EXPIRES parameter as calculated in step E90 or E100. This acknowledgment method serves to smooth the REGISTER requests sent by the UA terminals managed by the CSCF entity.

Very advantageously, this method makes it possible to smooth the signaling traffic associated with the REGISTER requests sent by the UA terminals managed by the CSCF entity.

A similar method having its main steps shown in FIGS. 8A and 8B can be implemented by the service brick BS in order to smooth the SUBSCRIBE subscription request sent by the terminals accessing the services made available by the brick.

This method is performed in exactly the same way as the acknowledgment method described above with reference to FIGS. 6A and 6B.

Thus, to summarize, the service brick BS counts the number SAPS of SUBSCRIBE requests received by the brick BS in each second of an observation stage (step F10).

Thereafter, it calculates the average SAPS_AVG of these numbers during a step F20.

During a step F30, the service brick BS estimates that the number of requests that are likely to be received by the service brick BS after the observation stage will reproduce exactly the number perceived during the observation stage.

Thereafter, on receiving a SUBSCRIBE request (step F50), the service brick sets:

a nominal EXPIRES period in step F90 if the number SAPS of subscription requests received during the last second is less than or equal to the average number SAPS_AVG of SUBSCRIBE requests calculated in step F20; or

an adjusted EXPIRES period calculated during a general step F100 shown in detail in FIG. 8B, comprising steps L10 to L60 similar to the steps K10 to K60 described with reference to FIG. 6A.

An acknowledgment message is sent to the UA terminal in question during a step F110 together with the EXPIRES parameter as calculated during the step F90 or F100. This acknowledgment method serves to smooth the SUBSCRIBE subscription requests sent by the UA terminals accessing a service made available by the service brick BS.

The steps F35, F40, F60, F65, F67, F70, and F80 are similar to the steps E35, E40, E60, E65, E67, E70, and E80, and they are not described herein.

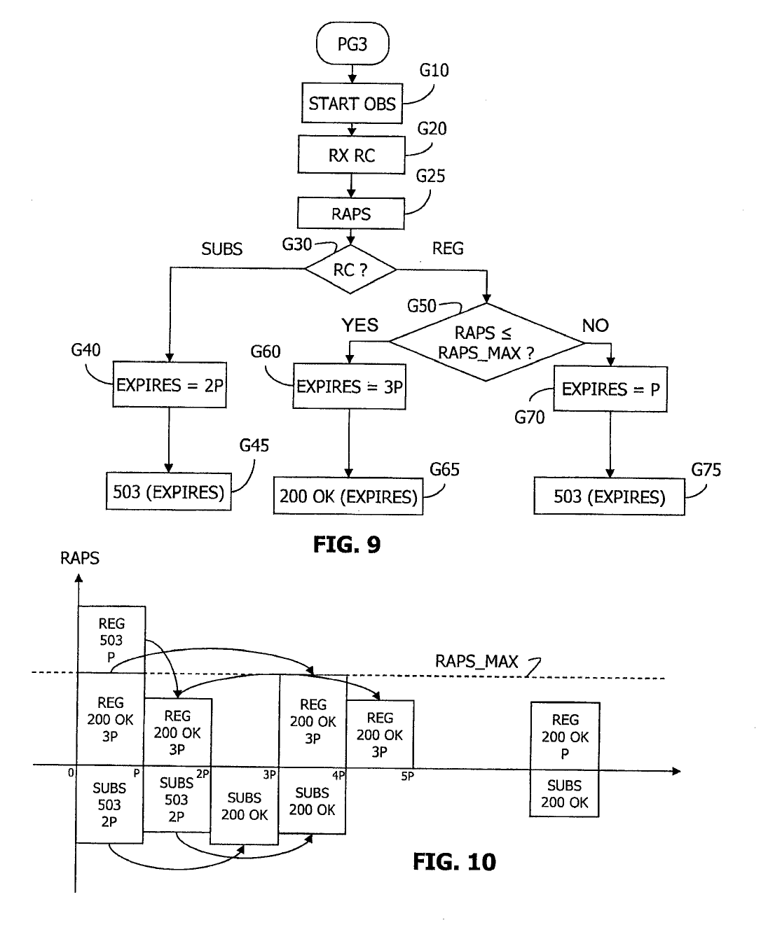

With reference to FIGS. 9 and 10, there follows a description of a method that may be implemented by a CSCF entity after repairing a breakdown that involves a central element in the core of an IMS network.

In the implementation described herein, this method includes a step G10 of starting a stage of observing a duration P corresponding to a nominal period set by the CSCF entity for acknowledging the REGISTER requests received by said entity.

It is assumed that the CSCF entity receives a current request RC during a step G20, which request may be of the REGISTER type or of the SUBSCRIBE type.

During a step G25, the CSCF entity calculates the current number RAPS of REGISTER requests received by the CSCF entity during the last second.

Furthermore, during a step G30, the CSCF entity determines whether the current request RC is a SUBSCRIBE request or a REGISTER request.

If the current request is a SUBSCRIBE request, then the CSCF entity acts during a step G40 to set the EXPIRES parameter at a first value, which value is selected in this example as being equal to twice the nominal period P.

The CSCF entity then sends to the UA terminal originating this SUBSCRIBE request a 503 Service Unavailable rejection message including the value Retry After=2P (step G45).

If during the step G30 it is determined that the current request is a REGISTER request, then during a step G50 the CSCF entity determines whether the number RAPS of current REGISTER requests received during the last second is or is not less than the maximum number RAPS_MAX of REGISTER requests that can be processed by this entity.

If so, during a step G60, the CSCF entity sets the EXPIRES parameter at a second value, greater than the first value, and in this example equal to three times the nominal period 3P.

The CSCF entity then sends to the UA terminal that originated this REGISTER request a 200 OK acknowledgment message including the value EXPIRES=3P (step G65).

If during the test G50 it is determined that the number RAPS of REGISTER requests received during the last second is greater than the maximum number RAPS_MAX, then the CSCF entity acts in a step G70 to set the EXPIRES parameter to the nominal value P.

Then, during a step G75, the CSCF entity sends to the UA terminal that originates this REGISTER request an acknowledgment message of the 503 Service Unavailable type including the value P in the Retry After field.

FIG. 10 shows how signaling traffic varies in the network as a result of implementing the method described above with reference to FIG. 9.

The top portion of this diagram represents the processing of REGISTER requests, while the bottom portion represents processing SUBSCRIBE requests.

From these diagrams, it can be seen that the SUBSCRIBE request received during the first nominal period (between instants 0 and P), are rejected with a parameter EXPIRES=2P, such that they are re-sent subsequently during the instants 2P and 3P.

The RAPS_MAX first REGISTER requests are acknowledged (200 OK message) with a parameter 3P, such that the next REGISTER request sent by the terminals in question are sent between the instants 3P and 4P.

The REGISTER requests received after the RAPS_MAX^{th} request are rejected (message 503) with a parameter EXPIRES=P in the Retry After field, such that the terminals re-send a REGISTER request in the range P, 2P.

In the example of FIG. 10, the observation stage ends after the period 3P. The situation has then returned to normal, with REGISTER requests being acknowledged with the parameter P and SUBSCRIBE requests being accepted with a 200 OK message after applying the acknowledgment method as described with reference to FIGS. 5 to 8 in order to smooth the traffic in the IMS network.

With reference to FIG. 11, there follows a description of a variant of this method.

In this implementation, the CSCF entity uses three parameters NB_TOT, NB_REG and REG_ENG that are stored in the flash type memory 15, specifically:

NB_TOT: total number of UA terminals managed by the CSCF entity;

NB_REG: number of UA terminals registered in said entity at a given instant; and

REG_ENG: number of REGISTER requests sent per second by the already-registered terminals. This number may be obtained by calculating NB_REG/P_DEF, where P_DEF is the default period for the REGISTER request.

According to these definitions:

(NB_TOT-NB_REG) represents the number of terminals that remain to be registered; and

(RAPS_MAX-REG_ENG) represents the maximum number of requests that can be processed per second, this number taking account of the terminals that are already registered and that will attempt to re-register.

This method includes a step H10 that is typically implemented on exiting a breakdown in order to calculate the minimum duration TMIN needed by the CSCF entity in order to process the first REGISTER requests that will be sent by all of the UA terminals managed by the CSCF entity that are not already registered.

This value may be calculated using the following formula:

TMIN=(NB_TOT−NB_REG)/(RAPS_MAX−REG_ENG)

When the CSCF entity receives a current request RC (of the SUBSCRIBE or REGISTER type) in the step H20, it acts in the step H25 to calculate the number RAPS of REGISTER requests received since the last second or during a time lapse that is defined in the configuration of the system.

Thereafter, during a step H28, the CSCF entity determines whether the number RAPS is less than or equal to the maximum number RAPS_MAX of REGISTER requests that can be processed per second by the CSCF entity.

If so, the CSCF entity sets the parameter EXPIRES to the nominal value P (step H30), and acts during a step H35 to send a positive acknowledgment message (200 OK) including this parameter to the UA terminal that sent the current request RC.

Otherwise, if it is determined in step H28 that the number RAPS_MAX has already been reached, then the CSCF entity sets the EXPIRES value to the value TMIN (step H40), and acts in a step H45 to send a rejection message 503 Service Unavailable with Retry After=TMIN to the terminal UA.

The acknowledgment methods described in FIGS. 9 to 11 enable traffic to be reduced very quickly on exiting a breakdown.

They may naturally be followed by an acknowledgment method as described with reference to FIGS. 5 to 8 in order to smooth the traffic in the IMS network.

In the above description, consideration is given to the situation in which the UA terminal accesses the CSCF entity of the IMS network directly.

Naturally, the invention also applies when the UA terminal access the CSCF entity via intermediate equipment, e.g. session border controller (SBC) equipment, where such equipment may implement a so-called “registration caching” mechanism such that different registration periods can be used in the access network and in the core network. Under such circumstances, the mechanism of the invention is implemented in distributed manner in the CSCF entity and in the SBC in order to take account of the EXPIRES values as set by the CSCF entity.

1. An acknowledgment method suitable for implementing in an entity of a telecommunications network in order to acknowledge a request of a determined type sent by a terminal and received by said entity, a request of the same type being liable to be re-sent by said terminal after a time period as defined by said entity and sent to said terminal in a message acknowledging said request, the method comprising:
a step of receiving a request of said type, referred to as a current request;
a step of estimating, for at least one future time window, the number of requests of said type that are liable to be received by said entity during said future time window;
a step of selecting a future time window among said at least one future time window; and
a step of sending to the terminal that sent said current request, an acknowledgment message including a period selected so that the next request of the same type as sent by said terminal will be sent during said selected future window.

2. The acknowledgment method according to claim 1, further comprising:
an observation step consisting, for each time period of an observation stage, in counting the number of requests of said type that are received by said entity during said time period;
said step of estimating the number of requests of said type that are liable to be received by said entity during a future time window being performed on the basis of said observation.

3. The acknowledgment method according to claim 2, wherein said selection step consists in selecting a future time window for which the number of requests is less than or equal to an average value calculated over all of said observation stage.

4. The acknowledgment method according to claim 1, further comprising:
a step of starting an observation stage, the observation stage having a duration equal to a nominal time period as defined by said entity for said requests that are of a priority type; and
a step of calculating the current number of requests of the priority type received by said entity during a predetermined duration preceding the reception of said current request;
the period sent to the terminal in said acknowledgment message being:
a first value greater than said nominal value if said current request is not of the priority type;
a second value, greater than said first value, if said current request is of the priority type, said current number being less than or equal to a maximum number of requests of said priority type that can be processed by said entity during said determined duration; or
said nominal value if said current request is a request of the priority type and said current number is greater than said maximum number.

5. The acknowledgment method according to claim 1, further comprising:
a step of calculating, as a function of a maximum number of requests of a priority type that can be processed by said entity during a determined duration, a minimum duration for processing the first requests of said priority type that are liable to be received from terminals that are managed by said entity but that are not registered in the network; and
a step of calculating the current number of requests of the priority type received by said entity during a determined duration preceding the reception of said current request;
the period sent to the terminal in said acknowledgment message being:
a nominal value if said current number is less than or equal to said maximum number; or
said minimum duration if said current number is greater than said maximum number.

6. A computer program including instructions for executing the steps of the acknowledgment method according to claim 1 when said program is executed by a computer.

7. A computer readable recording medium having a computer program recorded thereon that includes instructions for executing the steps of the acknowledgment method according to claim 1.

8. An entity of a telecommunications network, the entity comprising:
receiver means for receiving a request of a determined type sent by a terminal, referred to as the current request, said request being liable to be re-sent by said terminal after a time period defined by said entity and sent to said terminal in an acknowledgment message acknowledging said request;
estimation means for estimating, for at least one future time window, the number of requests of said type that are liable to be received by said entity during said future time window;
selection means for selecting a future time window from said at least one future time window; and
sender means for sending an acknowledgment message to said terminal, the acknowledgment message including a period selected so that the next request of said type as sent by said terminal will be sent during said selected future window.

9. An The entity according to claim 8, wherein the entity is a CSCF type entity comprising:
observation means suitable for counting the number of SIP REGISTER requests received per second during an observation stage;
receiver means for receiving a current SIP REGISTER request from a terminal; and
sender means for sending to said terminal, in response to said current request, an acknowledgment message including a period selected so that the next SIP REGISTER request sent by said terminal will be sent during a time window such that the estimated number of SIP REGISTER requests that are liable to be received by said CSCF entity during said time window is less than or equal to an average value of the number of SIP REGISTER requests received during the observation stage.

10. The entity according to claim 8, wherein the entity is a service brick in an SIP signaling network, comprising:
observation means suitable for counting the number of SIP SUBSCRIBE requests received per second during an observation stage;
receiver means for receiving a current SIP SUBSCRIBE request from a terminal;
sender means for sending to said terminal, in response to said current request, an acknowledgment message including a period selected so that the next SIP SUBSCRIBE request sent by said terminal will be sent during a time window such that the estimated number of SIP SUBSCRIBE requests liable to be received by said service brick during said time window is less than or equal to an average value for the number of SIP SUBSCRIBE requests received during the observation stage.

11. The entity according to claim 8, wherein the entity is a CSCF type entity comprising:
starter means for starting an observation stage having a duration equal to a nominal time period as defined by said CSCF entity for SIP REGISTER requests;
the period sent to the terminal in said acknowledgment message being:
a first value greater than said nominal value if the current request is an SIP SUBSCRIBE request;
a second value greater than said first value if the current request is an SIP REGISTER request, the number of SIP REGISTER requests received by said CSCF entity during the second preceding the reception of said current request being less than or equal to the maximum number of SIP REGISTER requests that can be processed by said CSCF entity in one second; or
the nominal value if said current request is an SIP REGISTER request, the number of SIP REGISTER requests received by said CSCF entity during the second preceding the reception of said current request being greater than the maximum number of SIP REGISTER requests that can be processed by said CSCF entity in one second.

12. The entity according to claim 11, wherein said first value is equal to twice the nominal period, and said third value is equal to three times the nominal period.

13. The entity according to claim 8, wherein the entity is an entity of the CSCF type comprising:
calculation means for calculating as a function of the maximum number of SIP REGISTER requests that can be processed by said CSCF entity per second, a minimum duration for processing the first SIP REGISTER requests that are liable to be received from terminals that are managed by the CSCF entity but that are not registered in the network; and
calculation means for calculating the current number of SIP REGISTER requests received by the entity during the second preceding the reception of the current request;
the period sent to the terminal in said acknowledgment message being:
a nominal value if said current number is less than or equal to said maximum number; or
said minimum duration if said current number is greater than said maximum number.
